(19) United States
(12) Patent Application Publication
(10) Pub. No.: US 2025/0026224 A1
(43) Pub. Date: Jan. 23, 2025

(54) OPERATION MANAGEMENT SYSTEM AND OPERATION MANAGEMENT METHOD

(71) Applicant: Panasonic Automotive Systems Co., Ltd., Kanagawa (JP)

(72) Inventors: Makoto HINATA, Kanagawa (JP); Fumio KOSUGE, Kanagawa (JP)

(73) Assignee: Panasonic Automotive Systems Co., Ltd., Kanagawa (JP)

(21) Appl. No.: 18/758,158

(22) Filed: Jun. 28, 2024

(30) Foreign Application Priority Data
Jul. 20, 2023 (JP) 2023-117927

(51) Int. Cl. B60L 53/62; B60L 53/18; B60L 53/66

(52) U.S. Cl. CPC B60L 53/62; B60L 53/18; B60L 53/66

(57) ABSTRACT

An operation management system includes: a server; a first obtainer that obtains charge amount information on a charge amount of an electric vehicle; a first transmitter that transmits the charge amount information obtained by the first obtainer to the server; a second obtainer that obtains driving history information on a driving history of the electric vehicle; and a second transmitter that transmits the driving history information obtained by the second obtainer. The server includes: an estimator that obtains the charge amount information and the driving history information, and estimates a potential range of travel of the electric vehicle based on the charge amount information and the driving history information obtained; and a display controller that causes a display to display an estimation result of the estimator.

### CROSS REFERENCE TO RELATED APPLICATION

The present application is based on and claims priority of Japanese Patent Application No. 2023-117927 filed on Jul. 20, 2023.

### FIELD

The present disclosure relates to an operation management system and an operation management method for managing operation of an electric vehicle.

### BACKGROUND

A system for assisting in the driving of an electric vehicle is known (refer to Patent Literature (PTL) 1 for example). In the system, when it is determined that charging is necessary based on a comparison of potential range of travel and scheduled traveling distance, a charging station located at a distance from the current location that is within the scope of the potential range of travel is identified, and the driver is alerted to the charging station identified.

### CITATION LIST

### Patent Literature

PTL 1: Japanese Unexamined Patent Application Publication No. 2015-94695

### SUMMARY

However, the above-mentioned conventional system can be improved upon.

In view of this, the present disclosure provides an operation management system and an operation management method that can further improve upon the related art.

An operation management system according to one aspect of the present disclosure is an operation management system for managing operation of an electric vehicle, and the operation management system includes: a server; a first obtainer that obtains charge amount information on a charge amount of the electric vehicle; a first transmitter that transmits the charge amount information obtained by the first obtainer to the server; a second obtainer that obtains driving history information on a driving history of the electric vehicle; and a second transmitter that transmits the driving history information obtained by the second obtainer, wherein the server includes: an estimator that obtains the charge amount information and the driving history information, and estimates a potential range of travel of the electric vehicle based on the charge amount information and the driving history information obtained; and a display controller that causes a display to display an estimation result of the estimator.

It should be noted that these generic and specific aspects may be implemented as a system, a method, an integrated circuit, a computer program, or a computer-readable recording medium, such as a compact disc-read only memory (CD-ROM), or may be implemented as any combination of a system, a method, an integrated circuit, a computer program, and a recording medium.

An operation management system according to one aspect of the present disclosure, and the like, can further improve upon the related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a conceptual diagram illustrating an outline of an operation management system according to an embodiment.

FIG. 2 is a block diagram illustrating a functional configuration of the operation management system according to the embodiment.

FIG. 3 is a sequence diagram illustrating a flow of operation of the operation management system according to the embodiment.

FIG. 4 is a diagram illustrating an example of display contents of a display of a terminal device according to the embodiment.

FIG. 5 is a diagram illustrating another example of display contents of the display of the terminal device according to the embodiment.

FIG. 6 is a diagram illustrating yet another example of display contents of the display of the terminal device according to the embodiment.

FIG. 7 is a diagram illustrating once again yet another example of display contents of the display of the terminal device according to the embodiment.

### DESCRIPTION OF EMBODIMENT

### Underlying Knowledge Forming Basis of the Present Disclosure

In relation to the technique described in the “Background Art” section, the inventors have found the following point to be problematic.

In the above-mentioned conventional system, since the system is a closed system contained in an electric vehicle, when a delivery company, for example, owns a plurality of electric vehicles, the delivery company cannot use the above-mentioned conventional system to manage operation of the plurality of electric vehicles in a consolidated manner.

In order to address this point, an operation management system according to a first aspect of the present disclosure is an operation management system for managing operation of an electric vehicle, and the operation management system includes: a server; a first obtainer that obtains charge amount information on a charge amount of the electric vehicle; a first transmitter that transmits the charge amount information obtained by the first obtainer to the server; a second obtainer that obtains driving history information on a driving history of the electric vehicle; and a second transmitter that transmits the driving history information obtained by the second obtainer. The server includes: an estimator that obtains the charge amount information and the driving history information, and estimates a potential range of travel of the electric vehicle based on the charge amount information and the driving history information obtained; and a display controller that causes a display to display an estimation result of the estimator.

According to this aspect, the estimator of the server estimates the potential range of travel of the electric vehicle based on the charge amount information and the driving history information, and the display controller of the server causes the display to display the estimation result of the estimator. Accordingly, when a delivery company or the like, for example, owns a plurality of electric vehicles, the delivery company or the like, can grasp the potential range of travel of each of the plurality of electric vehicles, thus allowing for operation of the plurality of electric vehicles to be managed in a consolidated manner.

Furthermore, an operation management system according to a second aspect of the present disclosure is the operation management system according to the first aspect of the present disclosure, wherein the electric vehicle or charging equipment for charging the electric vehicle may include a charging cable for electrically connecting the electric vehicle and the charging equipment, and the first obtainer and the first transmitter may be disposed in an adapter that is to be electrically connected to one end of the charging cable.

According to this aspect, the charge amount information can be obtained by using the adapter that is to be electrically connected to one end of the charging cable and the charge amount information can be transmitted to the server.

Furthermore, an operation management system according to a third aspect of the present disclosure is the operation management system according to the first aspect or the second aspect of the present disclosure, and further includes: a mobile terminal. The first transmitter may transmit the charge amount information to the server via the mobile terminal.

According to this aspect, communication costs incurred by the first transmitter can be reduced.

Furthermore, an operation management system according to a fourth aspect of the present disclosure is the operation management system according to the third aspect of the present disclosure, wherein the first transmitter may transmit the charge amount information to the mobile terminal by close-range wireless communication, and the mobile terminal may transfer the charge amount information transmitted by the first transmitter to the server via a network.

According to this aspect, communication costs incurred by the first transmitter can be reduced.

Furthermore, the operation management system according to a fifth aspect of the present disclosure is the operation management system according to the fourth aspect of the present disclosure, wherein the close-range wireless communication may be established by Bluetooth (registered trademark).

Furthermore, the operation management system according to a sixth aspect of the present disclosure is the operation management system according to any one of the first through fifth aspects of the present disclosure, wherein the second obtainer and the second transmitter may be disposed in an in-vehicle device that is provided in the electric vehicle and is compliant with electronic toll collection (ETC) 2.0, the second transmitter may transmit the driving history information to an intelligent transport systems (ITS) spot, and the estimator of the server may obtain the driving history information via the ITS spot.

According to this aspect, the driving history information can be transmitted using an existing in-vehicle device that is compliant with ETC 2.0.

Furthermore, an operation management method according to a seventh aspect of the present disclosure is an operation management method for managing operation of an electric vehicle, the operation management method comprising: (a) obtaining charge amount information on a charge amount of the electric vehicle; (b) transmitting the charge amount information obtained in (a) to a server; (c) obtaining driving history information on a driving history of the electric vehicle; (d) transmitting the driving history information obtained in (c); (e) obtaining, by the server, the charge amount information and the driving history information, and estimating a potential range of travel of the electric vehicle based on the charge amount information and the driving history information obtained; and (f) causing, by the server, a display to display an estimation result of (e).

According to this aspect, as described above, operation of the plurality of electric vehicles can be managed in a consolidated manner.

It should be noted that these generic and specific aspects may be implemented as a system, a method, an integrated circuit, a computer program, or a computer-readable recording medium, such as a CD-ROM, or may be implemented as any combination of a system, a method, an integrated circuit, a computer program, and a recording medium.

Hereinafter, an exemplary embodiment will be specifically described with reference to the drawings.

It should be noted that the embodiment described below merely illustrates general or specific examples of the present disclosure. The numerical values, shapes, materials, elements, the arrangement and connection states of the elements, steps, the order of the steps, etc., described in the following embodiment are mere examples, and are therefore not intended to limit the present disclosure. Accordingly, among elements in the following embodiment, those not appearing in any of the independent claims that indicate the broadest concepts of the present disclosure will be described as optional elements.

### Embodiment

### 1. Outline of Operation Management System

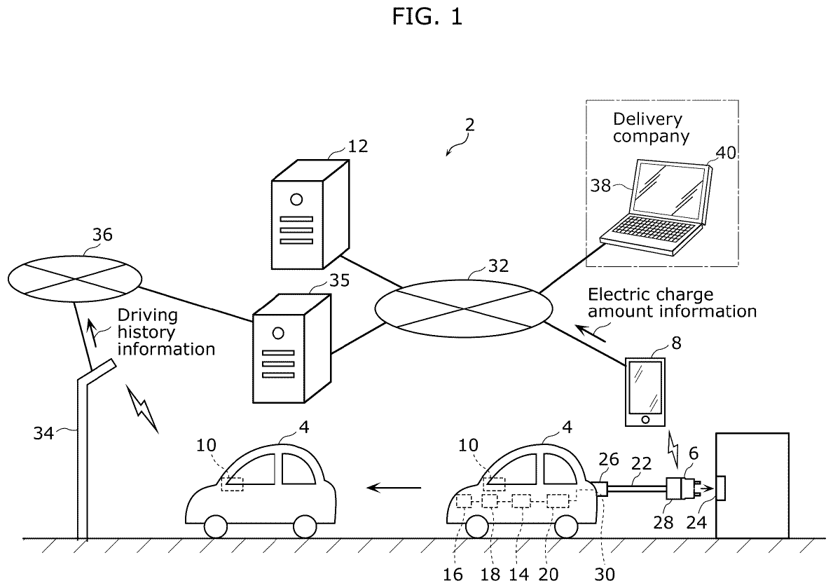

First, an outline of operation management system 2 according to an embodiment will be described with reference to FIG. 1. FIG. 1 is a conceptual diagram illustrating an outline of operation management system 2 according to the embodiment.

As illustrated in FIG. 1, operation management system 2 according to the embodiment is a system for managing operation of electric vehicle 4. Operation management system 2 includes adapter 6, mobile terminal 8, in-vehicle device 10, and server 12. It should be noted that for illustrative purposes, although only one electric vehicle 4 is illustrated in FIG. 1, in reality, operation management system 2 manages operation of a plurality of electric vehicles 4 in a consolidated manner.

Electric vehicle 4 is, for example, a passenger car, truck, or the like used to perform business activities that is owned by a delivery company. Electric vehicle 4 includes battery 14, motor 16, motor driver 18, and charging circuit 20. Battery 14 is a secondary battery that can be repeatedly charged. Motor 16 is a motor that causes electric vehicle 4 to travel. Motor driver 18 drives motor 16 according to driving operations performed by a driver by using power stored in battery 14. Charging circuit 20 is electrically connected to charging equipment 24 via charging cable 22, and charges battery 14 using power supplied by charging equipment 24.

It should be noted that electric vehicle 4 may be an electric vehicle (EV) that travels by using only motor 16, or may be a plug-in hybrid electric vehicle (PHEV) that travels by using both motor 16 and an engine (not illustrated in the figures). Furthermore, electric vehicle 4 is not limited to being a four-wheel electric vehicle, and may be a two-wheel or three-wheel electric vehicle.

Connector 26 is disposed on one end of charging cable 22 and plug 28 is disposed on another end of charging cable 22. Connector 26 is electrically connected in an attachable and detachable manner to charging circuit 20 via charging port 30 of electric vehicle 4. Plug 28 is electrically connected in an attachable and detachable manner to charging equipment 24. Charging equipment 24 is, for example, an outdoor power outlet.

It should be noted that in the present embodiment, although charging equipment 24 is an outdoor power outlet, this example is not limiting, and charging equipment 24 may be a charger that is installed at a charging spot, for example. In this case, a charging cable can be drawn out from the charger and a connector may be disposed on the leading end of the charging cable.

Adapter 6 can be attached and detached and is electrically connected to plug 28 of charging cable 22. That is to say, plug 28 of charging cable 22 can be attached and detached and electrically connected to charging equipment 24 via adapter 6.

Although not illustrated in the figures, note that in a case where charging equipment 24 is a charger installed at a charging spot, adapter 6 can be attached and detached and electrically connected to a connector of a charging cable that is drawn out from the charger. In this case, the connector of the charging cable is, for example, a “CHArge de MOve” (CHAdeMO) (registered trademark) standard connector, and is electrically connected to charging port 30 of electric vehicle 4 via adapter 6.

Adapter 6 has a measurement function for measuring the charge amount and a communication function for externally transmitting, by wireless communication, charge amount information on the charge amount. That is to say, while battery 14 of electric vehicle 4 is being charged using power from charging equipment 24, adapter 6 measures (obtains) the charge amount of battery 14. Furthermore, after charging of battery 14 is complete, adapter 6 transmits the charge amount information to mobile terminal 8 by close-range wireless communication, such as Bluetooth (registered trademark), for example. It should be noted that the charge amount information includes information indicating the charge amount measured by adapter 6 and information indicating the date and time at which battery 14 of electric vehicle 4 was charged.

Mobile terminal 8 is, for example, a smartphone, tablet, or the like that a user (driver of electric vehicle 4 or the like), for example, possesses. Mobile terminal 8 can communicate with adapter 6 by close-range wireless communication. Furthermore, mobile terminal 8 can communicate with server 12 via network 32, which is, for example, the Internet or the like. Mobile terminal 8 receives the charge amount information from adapter 6 by close-range wireless communication, and transfers the charge amount information received to server 12 via network 32. That is to say, adapter 6 transmits the charge amount information to server 12 via mobile terminal 8.

In-vehicle device 10 is, for example, an in-vehicle device that is compliant with the electronic toll collection (ETC) 2.0 standard and is equipped in electric vehicle 4. In-vehicle device 10 obtains position information indicating the current position of electric vehicle 4 by using a global positioning system (GPS) each time electric vehicle 4 travels a predetermined distance (200 m, for example). That is to say, in-vehicle device 10 obtains position information on in-vehicle device 10 at predetermined intervals of distance traveled (200 m, for example) as driving history information (probe data) on the driving history of electric vehicle 4. Furthermore, in-vehicle device 10 transmits the driving history information to intelligent transport systems (ITS) spot 34 when electric vehicle 4 is traveling in the vicinity of an ITS spot 34 installed on a road.

ITS spot 34 can communicate, via ITS spot network 36, with management server 35 that is managed by the Ministry of Land, Infrastructure, Transport and Tourism of Japan. ITS spot 34 receives the driving history information from in-vehicle device 10 and transmits the driving history information received to management server 35 via ITS spot network 36. It should be noted that management server 35 is a server for managing driving history information, and only business operators that have received permission in advance from the Ministry of Land, Infrastructure, Transport and Tourism of Japan can communicate with server 12 via network 32.

Server 12 is, for example, a cloud server. Server 12 receives the charge amount information from mobile terminal 8 and the driving history information from management server 35 via network 32. Server 12 estimates the potential range of travel of electric vehicle 4 based on the charge amount information and the driving history information that have been received. Additionally, server 12 causes display 38 to display information, via network 32, indicating the potential range of travel (estimated results) that has been estimated.

Display 38 is, for example, a display of terminal device 40 that has been installed at a delivery company. It should be noted that terminal device 40 may be, for example, a personal computer, a smartphone, a tablet, or the like.

### 2. Functional Configuration of Operation Management System

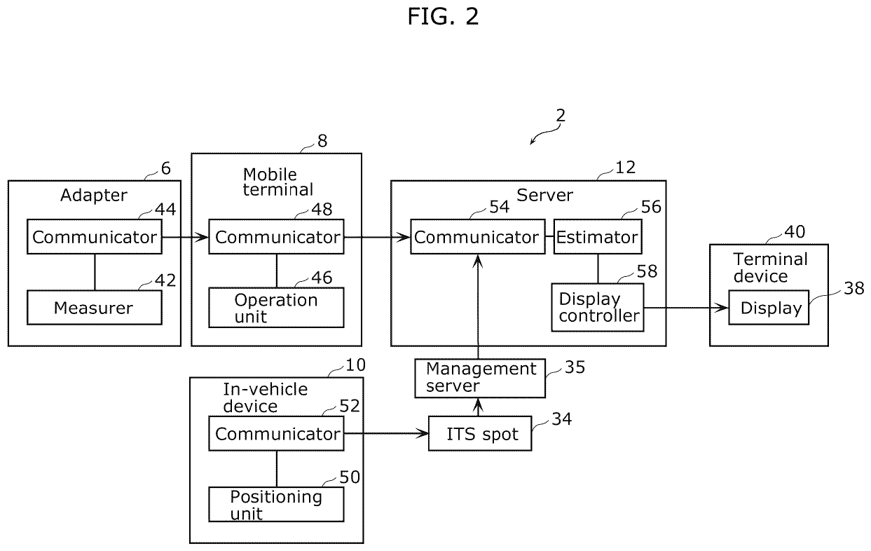

Next, the functional configuration of operation management system 2 according to the embodiment will be described with reference to FIG. 2. FIG. 2 is a block diagram illustrating a functional configuration of operation management system 2 according to the embodiment.

As illustrated in FIG. 2, adapter 6 includes, as functional elements, measurer 42 (an example of a first obtainer) and communicator 44 (an example of a first transmitter). That is to say, while battery 14 of electric vehicle 4 is being charged using power from charging equipment 24, measurer 42 measures (obtains) the charge amount of battery 14. Additionally, after battery 14 is completely charged, communicator 44 transmits the charge amount information measured by measurer 42 to mobile terminal 8 by close-range wireless communication.

Mobile terminal 8 includes, as functional elements, operation unit 46 and communicator 48. Operation unit 46 receives operations from a user. Specifically, operation unit 46 receives input from the user related to default setting information, such as the maximum charge capacity, initial remaining charge amount, and the like, of battery 14, for example. Here, maximum charge capacity refers to the maximum amount of power that battery 14 can be charged with, and the initial remaining charge amount refers to the remaining amount of charge of battery 14 (SOC: State Of Charge) when battery 14 is in its initial state before being charged. Communicator 48 receives the charge amount information from adapter 6 by close-range wireless communication, and transfers the charge amount information received to server 12 via network 32 (see FIG. 1). That is to say, communicator 44 of adapter 6 transmits the charge amount information to server 12 via mobile terminal 8. Additionally, communicator 48 transmits the default setting information received by operation unit 46 to server 12 via network 32.

In-vehicle device 10 includes, as functional elements, positioning unit 50 (an example of a second obtainer) and communicator 52 (an example of a second transmitter). Positioning unit 50 obtains position information indicating the current position of electric vehicle 4 by using a GPS each time electric vehicle 4 travels a predetermined distance (200 m, for example). That is to say, positioning unit 50 obtains position information at predetermined intervals of distance traveled (200 m, for example) as driving history information on the driving history of electric vehicle 4. When electric vehicle 4 travels in the vicinity of an ITS spot 34 installed on a road, communicator 52 transmits driving history information obtained by positioning unit 50 to ITS spot 34.

ITS spot 34 receives the driving history information from in-vehicle device 10 and transmits the driving history information to management server 35 via ITS spot network 36 (see FIG. 1).

Management server 35 receives the driving history information from ITS spot 34 and stores the driving history information received in memory. Additionally, management server 35 transmits the driving history information stored in memory to server 12 via network 32.

Server 12 includes, as functional elements, communicator 54, estimator 56, and display controller 58. Communicator 54 receives the charge amount information and default setting information from mobile terminal 8, and the driving history information from management server 35 via network 32.

Estimator 56 obtains the charge amount information and the driving history information from communicator 54, and estimates the potential range of travel of electric vehicle 4 based on the charge amount information and driving history information obtained. Specifically, estimator 56 calculates the electric mileage (rate of electrical power consumption) of electric vehicle 4 based on the maximum charge capacity and initial remaining charge amount included in the default setting information, as well as the cumulative charge capacity and cumulative driving distance calculated from the charge amount information and the driving history information. Then, estimator 56 estimates the potential range of travel of electric vehicle 4 based on the electric mileage calculated and the current remaining charge amount calculated from the initial remaining charge amount and charge amount information. Here, potential range of travel refers to the distance that can be traveled by electric vehicle 4 from the current location before the current remaining charge amount is completely used up.

Display controller 58 transmits, via network 32, information indicating the potential range of travel (estimation result) estimated by estimator 56 to terminal device 40. That is to say, display controller 58 causes display 38 of terminal device 40 to display information that indicates the potential range of travel estimated by estimator 56 via network 32.

### 3. Operations of the Operation Management System

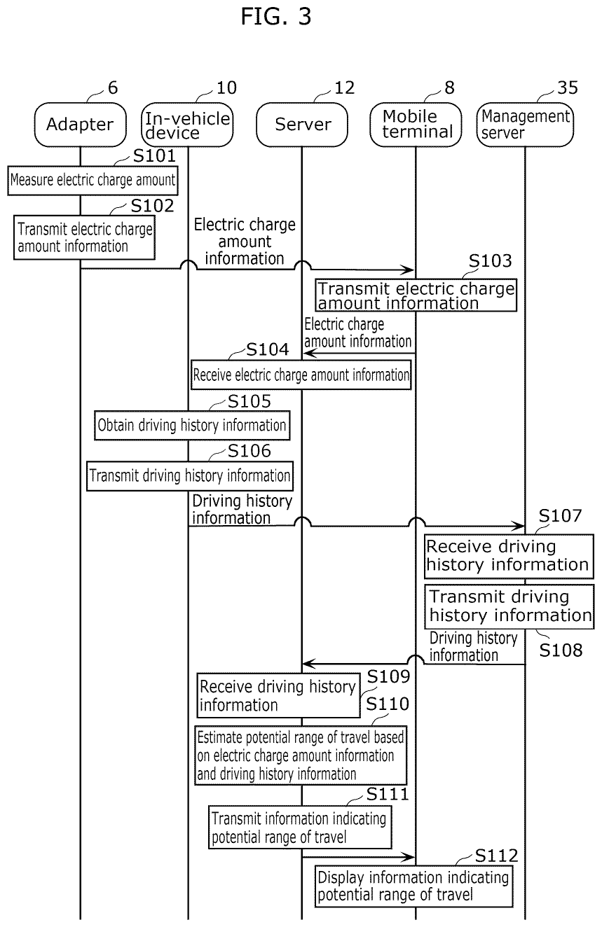

Next, the operations performed by operation management system 2 according to the embodiment will be described with reference to FIG. 3. FIG. 3 is a sequence diagram illustrating the flow of operation of operation management system 2 according to the embodiment.

As illustrated in FIG. 3, when battery 14 of electric vehicle 4 is charged using power from charging equipment 24, measurer 42 of adapter 6 first measures the charge amount of battery 14 (S101).

Next, after battery 14 is completely charged, communicator 44 of adapter 6 transmits charge amount information that has been measured by measurer 42 to mobile terminal 8 (S102). Next, mobile terminal 8 transmits (transfers) the charge amount information received to server 12 (S103).

Next, communicator 54 of server 12 receives the charge amount information from mobile terminal 8 (S104).

Next, positioning unit 50 of in-vehicle device 10 obtains position information indicating the current position of electric vehicle 4 by using a GPS each time electric vehicle 4 travels a predetermined distance (200 m, for example). That is to say, positioning unit 50 obtains position information at predetermined intervals of distance traveled (200 m, for example) as driving history information on the driving history of electric vehicle 4 (S105).

Next, communicator 52 of in-vehicle device 10 transmits the driving history information obtained by positioning unit 50 to management server 35 via ITS spot 34 (S106). Next, management server 35 receives the driving history information from in-vehicle device 10 (S107) and transmits the driving history information received to server 12 (S108).

Next, communicator 54 of server 12 receives the driving history information from management server 35 (S109). Next, estimator 56 of server 12 obtains the charge amount information and the driving history information from communicator 54, and estimates the potential range of travel of electric vehicle 4 based on the charge amount information and the driving history information obtained (S110).

Next, display controller 58 of server 12 transmits information indicating the potential range of travel estimated by estimator 56 to terminal device 40 via network 32 (S111). Accordingly, information indicating the potential range of travel estimated by estimator 56 of server 12 is displayed on display 38 of terminal device 40 (S112).

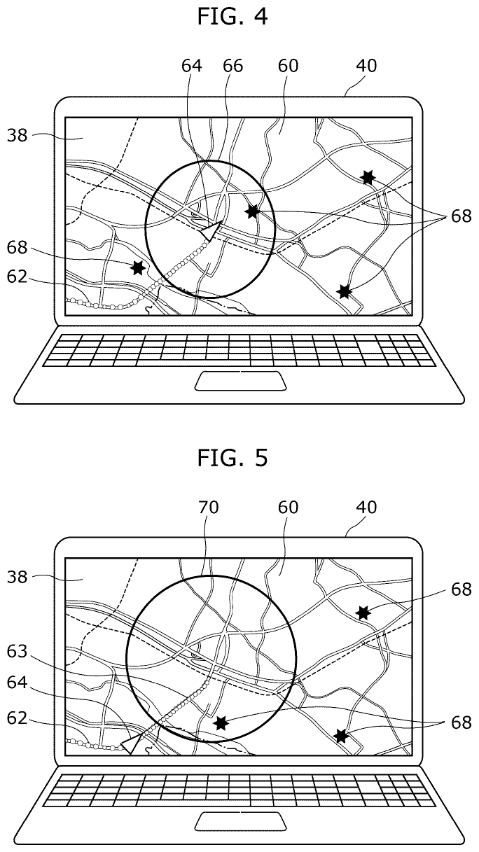

Here, an example of display contents of display 38 of terminal device 40 will be described with reference to FIG. 4. FIG. 4 is a diagram illustrating an example of display contents of display 38 of terminal device 40 according to the embodiment.

As illustrated in FIG. 4, map 60 of the region through which electric vehicle 4 is currently traveling, dotted line 62 that indicates the path of travel of electric vehicle 4, mark 64 that is triangular and indicates the current position of electric vehicle 4, circle 66 that is centered on the current position of electric vehicle 4 and has a radius equivalent to the distance of the potential range of travel estimated by estimator 56, and marks 68 that are star-shaped and each indicate a position of a charging spot at which electric vehicle 4 can be charged are displayed on display 38 of terminal device 40. That is to say, circle 66 indicates the scope of the potential range of travel from the current position of electric vehicle 4. It should be noted that mark 64 need not necessarily indicate the precise current position of electric vehicle 4, and may indicate the position of the ITS spot 34 nearest to the current position of electric vehicle 4.

An operator or the like of a delivery company can grasp the potential range of travel of electric vehicle 4 by looking at circle 66 displayed on display 38. Accordingly, an operator or the like of a delivery company can, for example, notify, by wireless communication, the driver of electric vehicle 4 of charging spots in the vicinity that can be reached from the current position before the current remaining charge amount is completely used up (i.e., a charging spot that corresponds to the mark 68 located inside of circle 66).

Hereinafter, other examples of display contents of display 38 of terminal device 40 will be described with reference to FIG. 5 through FIG. 7. FIG. 5 through FIG. 7 are diagrams illustrating other examples of display contents of display 38 of terminal device 40 according to the embodiment.

In the example illustrated in FIG. 5, map 60 of the region through which electric vehicle 4 is currently traveling, dotted line 62 that indicates the path of travel of electric vehicle 4, dotted line 63 that indicates the scheduled route of travel, mark 64 that is triangular and indicates the current position of electric vehicle 4, circle 70 that is centered on the destination of electric vehicle 4 and has a radius equivalent to the potential range of travel estimated by estimator 56, and marks 68 that are star-shaped and each indicate a position of a charging spot at which electric vehicle 4 can be charged are displayed on display 38 of terminal device 40. That is to say, circle 70 indicates the scope of the potential range of travel from the destination of electric vehicle 4.

In the example illustrated in FIG. 5, estimator 56 of server 12 calculates the amount of power that is to be consumed by the time electric vehicle 4 arrives at the destination based on the electric mileage and the travel distance from the current position of electric vehicle 4 to the destination. Then, estimator 56 calculates the predicted remaining charge amount that is the remaining amount of charge at the point in time at which electric vehicle 4 is to arrive at the destination by subtracting the amount of power that is to be consumed from the current remaining charge amount. Then, estimator 56 estimates the potential range of travel of electric vehicle 4 based on electric mileage and the predicted remaining charge amount calculated. Here, potential range of travel refers to the distance that can be traveled by electric vehicle 4 from the destination before the predicted remaining charge amount is completely used up.

An operator or the like of a delivery company can grasp the potential range of travel of electric vehicle 4 by looking at circle 70 displayed on display 38. Accordingly, an operator or the like of a delivery company can, for example, notify, by wireless communication, the driver of electric vehicle 4 of charging spots that can be reached from the destination before the predicted remaining charge amount is completely used up (i.e., a charging spot that corresponds to the mark 68 located inside of circle 70).

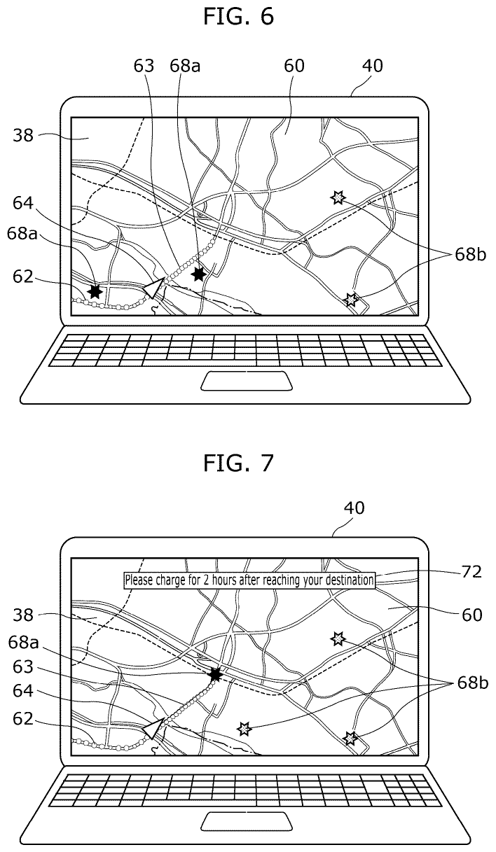

In the example illustrated in FIG. 6, map 60 of the region through which electric vehicle 4 is currently traveling, dotted line 62 that indicates the path of travel of electric vehicle 4, dotted line 63 that indicates the scheduled route of travel, mark 64 that is triangular and indicates the current position of electric vehicle 4, and marks 68a and marks 68b that are star-shaped and each indicate a position of a charging spot at which electric vehicle 4 can be charged are displayed on display 38 of terminal device 40. Marks 68a each indicate a position at which a charging spot that is relatively nearby the scheduled route of travel of electric vehicle 4 is located and are highlighted for emphasis using bold colors or the like, for example. Marks 68b each indicate a position at which a charging spot that is relatively far from the scheduled route of travel of electric vehicle 4 and are displayed using faint colors or the like, for example.

Accordingly, an operator or the like of a delivery company can, for example, notify, by wireless communication, the driver of electric vehicle 4 of the nearest charging spot from the scheduled route of travel of electric vehicle 4 by looking at marks 68a that are highlighted for emphasis and displayed on display 38.

In the example illustrated in FIG. 7, map 60 of the region through which electric vehicle 4 is currently traveling, dotted line 62 that indicates the path of travel of electric vehicle 4, dotted line 63 that indicates the scheduled route of travel, mark 64 that is triangular and indicates the current position of electric vehicle 4, mark 68a and marks 68b that are star-shaped and each indicate a position of a charging spot at which electric vehicle 4 can be charged, and message box 72 are displayed on display 38 of terminal device 40. Here, it should be noted that mark 68a is located at the destination of electric vehicle 4. That is to say, in this case, once electric vehicle 4 arrives at the destination, electric vehicle 4 can be charged using a charging spot located at the destination. In message box 72, a message is displayed to provide notification of the time needed to charge electric vehicle 4 using the charging spot located at the destination, which is, for example, a message such as that indicating “please charge for 2 hours after reaching your destination”, “please charge to increase charge level by 20 kWh after reaching your destination”, or the like.

In the example illustrated in FIG. 7, estimator 56 of server 12 calculates the time needed to charge electric vehicle 4 using the charging spot at the destination (12 kWh/6 kW=2 h, for example) based on the amount of power that needs to be charged for electric vehicle 4 to return to the point of origin from the destination (12 kWh, for example) and the output of the charger at the charging spot at the destination (6 kW, for example). Then, display controller 58 of server 12 generates message box 72 based on the time estimated by estimator 56.

Accordingly, an operator or the like of a delivery company can, for example, predict the time needed for electric vehicle 4 to return to the point of origin by looking at message box 72 displayed on display 38.

### 4. Advantageous Effects

In the present embodiment, estimator 56 of server 12 estimates the potential range of travel of electric vehicle 4 based on charge amount information and driving history information, and display controller 58 of server 12 causes display 38 to display an estimation result estimated by estimator 56. Accordingly, when a delivery company or the like, for example, owns a plurality of electric vehicles 4, the delivery company or the like, is able to grasp the potential range of travel of each of the plurality of electric vehicles 4, thus allowing for operation of the plurality of electric vehicles 4 to be managed in a consolidated manner.

### Other Variations

While an operation management system according to one e aspects has been described based on the or more above-mentioned embodiment, the present disclosure is not limited to the above-mentioned embodiment. Forms obtained by various modifications to the foregoing embodiment conceivable by those skilled in the art or forms obtained by combining elements in different embodiments, so long as they do not depart from the essence of the present disclosure, may be included in the one or more aspects.

In the above embodiment, although adapter 6 transmits charge amount information to server 12 via mobile terminal 8, this example is not limiting, and adapter 6 may directly transmit charge amount information to server 12 via network 32. In this case, adapter 6 may be equipped with a subscriber identity module (SIM) card.

Furthermore, in the embodiment above, although in-vehicle device 10 that is compliant with ETC 2.0 transmits driving history information to management server 35, this example is not limiting, and driving history information may be transmitted by various in-vehicle devices or the like other than in-vehicle device 10.

In the above-mentioned embodiment, each element may be configured as dedicated hardware, or may be implemented by executing a computer program suitable for each element. Alternatively, the elements may be implemented by a program executor, such as a CPU or a processor, reading and executing a computer program recorded in a recording medium, such as a hard disk or semiconductor memory.

Furthermore, a portion or all of the functions of the operation management system according to the above-mentioned embodiment may be implemented by a processor, such as a CPU, executing a computer program.

A portion or all of the elements included in the preceding devices may be configured as an IC card or stand-alone module that can be inserted and removed from the corresponding device. The IC card or the module is a computer system that includes a microprocessor, ROM, RAM, and the like. The IC card or the module may include the super-multifunctional LSI described above. The microprocessor operates according to the computer program, so that a function of the IC card or the module is achieved. The IC card or the module may be tamper-resistant.

The present disclosure may be a method described above. Furthermore, the present disclosure may be a computer program for causing a computer to execute the method, or may be a digital signal of the computer program. Additionally, the present disclosure may be the above-mentioned computer program or the digital signal recorded on a non-transitory, computer-readable recording medium, such as a flexible disk, hard disk, CD-ROM, MO, DVD, DVD-ROM, DVD-RAM, BD (Blu-ray (registered trademark) Disc), or semiconductor memory. Moreover, the present disclosure may be the digital signal recorded on the above-mentioned recording media. Furthermore, the present disclosure may be the above-mentioned computer program or the digital signal transmitted via an electric communication line, a wireless or wired communication line, a network, such as the Internet, data broadcasting, and the like. Additionally, the present disclosure may be a computer system including a microprocessor and memory. The memory may store the above-mentioned computer program, and the microprocessor may operate according to the computer program. Moreover, by transferring the recording medium having the above-mentioned program or digital signal recorded thereon or by transferring the above-mentioned program or digital signal via the above-mentioned network or the like, the present disclosure may be implemented by a different independent computer system.

While an embodiment has been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims is incorporated herein by reference in its entirety: Japanese Patent Application No. 2023-117927 filed on Jul. 20, 2023.

### INDUSTRIAL APPLICABILITY

The present disclosure is applicable to operation management systems for managing operation of electric vehicles, for example.

1. An operation management system for managing operation of an electric vehicle, the operation management system comprising:
a server;
a first obtainer that obtains charge amount information on a charge amount of the electric vehicle;
a first transmitter that transmits the charge amount information obtained by the first obtainer to the server;
a second obtainer that obtains driving history information on a driving history of the electric vehicle; and
a second transmitter that transmits the driving history information obtained by the second obtainer, wherein
the server includes:
an estimator that obtains the charge amount information and the driving history information, and estimates a potential range of travel of the electric vehicle based on the charge amount information and the driving history information obtained; and
a display controller that causes a display to display an estimation result of the estimator.

2. The operation management system according to claim 1, wherein
the electric vehicle or charging equipment for charging the electric vehicle includes a charging cable for electrically connecting the electric vehicle and the charging equipment, and
the first obtainer and the first transmitter are disposed in an adapter that is to be electrically connected to one end of the charging cable.

3. The operation management system according to claim 2, further comprising:
a mobile terminal, wherein
the first transmitter transmits the charge amount information to the server via the mobile terminal.

4. The operation management system according to claim 3, wherein
the first transmitter transmits the charge amount information to the mobile terminal by close-range wireless communication, and
the mobile terminal transfers the charge amount information transmitted by the first transmitter to the server via a network.

5. The operation management system according to claim 4, wherein
the close-range wireless communication is established by Bluetooth (registered trademark).

6. The operation management system according to claim 1, wherein
the second obtainer and the second transmitter are disposed in an in-vehicle device that is provided in the electric vehicle and is compliant with electronic toll collection (ETC) 2.0,
the second transmitter transmits the driving history information to an intelligent transport systems (ITS) spot, and
the estimator of the server obtains the driving history information via the ITS spot.

7. An operation management method for managing operation of an electric vehicle, the operation management method comprising:
(a) obtaining charge amount information on a charge amount of the electric vehicle;
(b) transmitting the charge amount information obtained in (a) to a server;
(c) obtaining driving history information on a driving history of the electric vehicle;
(d) transmitting the driving history information obtained in (c);
(e) obtaining, by the server, the charge amount information and the driving history information, and estimating a potential range of travel of the electric vehicle based on the charge amount information and the driving history information obtained; and
(f) causing, by the server, a display to display an estimation result of (e).
